(19) United States
(12) Patent Application Publication
(10) Pub. No.: US 2024/0039311 A1
(43) Pub. Date: Feb. 1, 2024

(54) Electric Vehicle Battery Charging and Support Rack

(71) Applicant: Ample Inc., San Francisco, CA (US)

(72) Inventors: Maya Padmalayam, San Francisco, CA (US); Matthew Gough, San Francisco, CA (US); Azriel Samson, San Francisco, CA (US)

(21) Appl. No.: 18/363,314

(22) Filed: Aug. 1, 2023

Related U.S. Application Data
(60) Provisional application No. 63/370,018, filed on Aug. 1, 2022.

(51) Int. Cl. H02J 7/00; B60L 53/80; B60L 53/30; B60L 53/62

(52) U.S. Cl. CPC H02J 7/0042; H02J 7/0013; B60L 53/80; B60L 53/30; B60L 53/62

(57) ABSTRACT

A rack-based system for charging, monitoring and maintaining a plurality of batteries is described. The system includes mechanical and electrical frameworks for achieving the foregoing as well as a communication framework for exchanging necessary data for achieving the same. A state machine and associated controllers and control signals are additionally provided for operating the present system.

### CROSS-REFERENCE TO RELATED APPLICATIONS

This application claims priority to U.S. Provisional Application No. 63/370,018, entitled “Electric Vehicle Battery Charging and Support Rack,” filed on Aug. 1, 2022, which is hereby incorporated by reference.

### TECHNICAL FIELD

This application relates to the design and operation of battery charging and support systems such as would be used to support the operation of electric vehicles.

### BACKGROUND

Current electric vehicles are generally powered by one or more batteries mounted in a fixed housing usually located in an enclosure or battery housing near the bottom of the vehicles. Such batteries are typically charged from a charging plug or port that provides electrical energy for charging the batteries when depleted and while the batteries remain within their housing within the vehicle.

Removal and installation of electric batteries in an electric vehicle is traditionally a complicated affair that renders the battery systems sometimes unserviceable except through expensive and time-consuming procedures. Therefore, batteries in an electric vehicle are usually treated as components that are not accessible for routine inspection and service, and the disassembly of entire battery units from the under carriage of an electric vehicle requires special heavy equipment, if it is even attempted. Servicing sub-assemblies in such battery units is generally not possible.

Improved controls and handling of electric vehicle batteries in the context of servicing and charging the same are desirable. The present disclosure and invention cure some or most of the foregoing limitations of existing electric vehicle battery and support systems.

### SUMMARY

A system and method for servicing, maintaining, storing, charging, testing and otherwise monitoring and servicing a plurality of separate electric vehicle battery modules is provided. A battery module may itself be a collection of a set or multiple subsets of individual electric power storage units (generally referred to as batteries) and these may be of any useful type and configuration and chemistry. For example, traditional wet batteries, e.g., lead acid, lithium ion, nickel cadmium or other chemistries are equally comprehended. Also, non-traditional electric energy storage units can be used in the invention as well such as capacitive or solid state or any other suitable unit for holding and delivering electric energy to a vehicle. As stated, the vehicles comprehended hereby may include any of a range of vehicles such as wheeled vehicles (cars, trucks, vans, buses, motorbikes, scooters, etc.) as well as flying vehicles, water vehicles and others.

The vehicles may be serviced at a service station as described. The service station may comprise one or more pods or bays and each may have a respective battery service system as described herein or they may share one or more aspects and components of such battery service systems.

In an aspect, the invention is directed to an electric vehicle battery service station supporting a system for servicing a plurality of electric vehicle battery modules, the system comprising an electro-mechanical rack assembly comprising one or more battery racks, each battery rack being arranged and configured to receive and hold one or more of said plurality of electric vehicle battery modules for servicing or storing in said battery rack, wherein said battery rack includes a plurality of battery module compartments, and wherein each of said compartments is configured and arranged to hold one of said electric vehicle battery modules, and each said compartment further comprises one or more electrical connection points configured and arranged to electrically couple to corresponding electrical connection points on an electric vehicle battery module therein; a plurality of battery chargers, one battery charger per battery rack, wherein each charger provides direct current (DC) electrical power to charge one or more battery modules disposed in the corresponding battery rack; a plurality of charger managers, one charger manager per battery rack, where each such charger manager comprises processing circuitry and is coupled to and is in data communication with at least said battery chargers so as to control said battery chargers according to program instructions within said charger manager, each of said charger managers further coupled to and in data communication with a corresponding respective list manager that comprises circuitry and instructions to determine a list of said battery modules coupled thereto; a charger collection manager coupled to and in data communication with each of said charger managers, where said charger collection manager comprises processing circuitry and executed program instructions within said charger collection manager to control said charger managers.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 illustrates a high-level arrangement of some entities and systems involved in servicing, charging and managing the present system and method.

FIG. 2 illustrates an electric vehicle having a plurality of battery modules, in communication with a battery service station.

FIG. 3 illustrates a logical and/or physical arrangement of a battery charging system, and accordingly a method, for managing the electrical state and charge of one or more swappable battery modules of an electric vehicle.

FIG. 4 illustrates an exemplary charger collection manager logic for managing, programming or operating a charger collection manager.

FIG. 5 illustrates a state chart describing the various states of the charger collection manager and their transitions.

FIG. 6 illustrates an exemplary embodiment of logic for managing, programming and operating a charger manager.

FIG. 7 illustrates a method, process or logic flow, which, as with other such flows can be programmed using machine readable instructions encoded into a digital storage unit for execution by one or more circuits of a processor.

FIG. 8 illustrates steps of a process in partial or full charging of battery modules and moving from a Partial Charge process to a Full Charge process.

FIG. 9 illustrates an overview of a process for charging according to embodiments of the present invention.

FIG. 10 illustrates an exemplary process and method carried out at least in part in said single group charging state machine.

FIG. 11 illustrates an exemplary process for charging a single group of battery modules.

FIG. 12 illustrates exemplary steps of a process for turning on a first battery module (BM) by setting a chosen BM from a list of modules in a single group to be charged.

FIG. 13 illustrates exemplary steps of a process for turning on a battery charger.

FIG. 14 illustrates a state where there exists or is flagged a charging failure.

FIG. 15 illustrates an exemplary charge stopping process for securing from a battery charging state in an electric vehicle charging system.

FIG. 16 illustrates an exemplary process for securing or turning off the high voltage (HV) DC power to all or part of the present system.

FIG. 17 illustrates a system level overview of a rack-based system for charging, monitoring, and maintaining a plurality of batteries.

FIG. 18 illustrates a shelf unit and controls of a rack based battery control and service system.

### DETAILED DESCRIPTION

The design and operation of an individual battery used for powering propulsion and accessory loads in electric vehicles is known and/or described in the art and will not be visited here in detail. Similarly, the design and operation of electric vehicles, which can include cars, trucks, public transportation, commercial, military, recreational vehicles whether operated on land, sea or air, is a concept not specifically addressed herein. The present electric vehicles may be human-operated, remotely operated, drones, or partially- or fully-self driving without limitation. The aspects covered herein relate a system and method for novel and effective charge management, servicing and testing of batteries, typically arranged into battery modules (BM) each BM comprising a plurality of individual batteries. Therefore, this disclosure and invention will apply to a wide variety of battery types (having various chemistries, physical construction or electrical characteristics) and will apply to a wide variety of electric vehicle applications.

One application of the present disclosure concerns electric vehicles equipped with swappable battery module systems. Such vehicles and battery systems are described by the present applicant, e.g., in U.S. Pub. No. 2020/0406780. In such vehicles, the onboard power storage takes the form of discretely installable and removeable battery modules that can be physically placed into and taken out of the battery module housing or compartment of the vehicle for servicing, testing and/or recharging. Rather than limiting these vehicles to being tethered to a battery charging station, the swappable battery vehicles can have their depleted battery modules removed from the vehicle and replaced by charged battery modules as described elsewhere including in the above-mentioned and related documents. The issues addressed by this disclosure and invention are thus when, where and how to process battery modules taken from or intended to be placed into such swap-enabled electric vehicles.

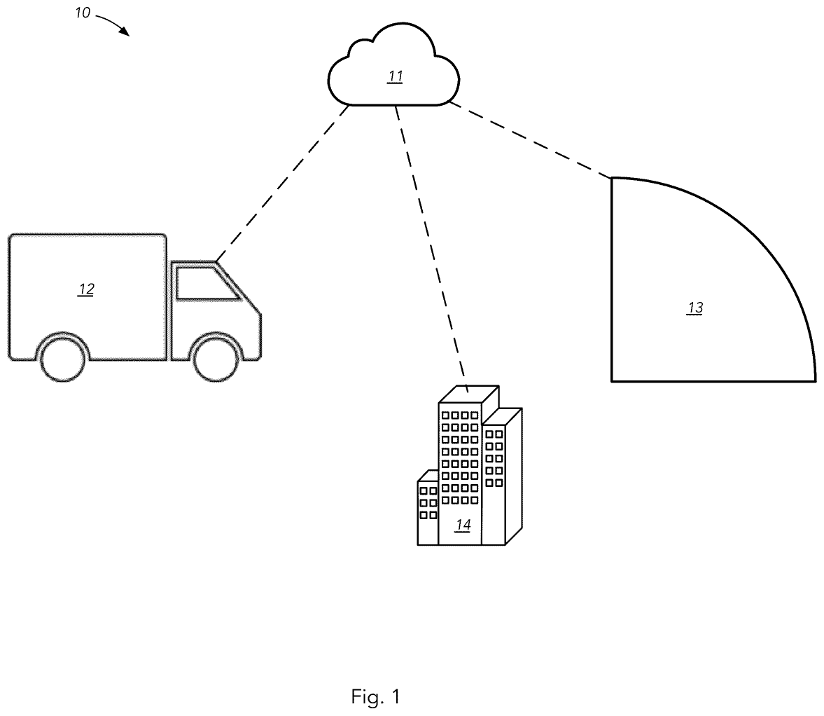

FIG. 1 illustrates a high-level arrangement 10 of some entities and systems involved in servicing, charging and managing the present system and method. An electrically powered vehicle 12 such as (but not limited to) a car, bus, truck or delivery fleet van runs about its business propelled by a bank of batteries powering a vehicle electric motor and other electric loads. The vehicle 12 battery system is serviced and managed at a station 13 which in its most general understanding is considered an energy management station, which includes but is not limited to one or more battery chargers as will be described below. A central service provider, system operator or the like is represented by 14 and may include a computer, server, processor-based controller or similar machine configured and arranged to exchange data and to process instructions such as program instructions. Each of these entities is in data communication with one another, either directly or indirectly, and such communication may be in the form of wired or wireless digital signal exchanges through one or more networks 11, cloud communication servers, web servers, application servers, and back end computer systems.

In some examples, a battery service and charging station is provided as a facility or service. The service station or pod may have a number of form factors including a drive-in or drive-up stationary unit, a portable (e.g., truck-based) mobile unit or other forms. Generally, an electric vehicle can pull up to or into such a station and human, mechanical, robotic or computer-controlled battery handling systems can be set about to access and swap individual (some or all) battery modules from said vehicle. One prior description of such stations is provided by the present applicant, e.g., U.S. Pat. No. 9,868,421, which is hereby incorporated by reference.

As will be described and exemplified below, the present system and method are preferably carried out using a rack style arrangement comprising one or more racks for storing, charging and servicing or managing a plurality of battery modules (sometimes abbreviated BM) placed thereon. A rack may further comprise a plurality of shelves where each shelf is configured and arranged to receive and support a plurality of battery modules. The hierarchical arrangement of the system, racks and shelves is connected with processing elements that can also be hierarchically allocated such as a Shelf Manager, Rack Manager and so on, which are interconnected using a suitable data connection architecture, bus or network for exchanging data necessary for the system's operation. Furthermore, the whole system 10 may be coupled to and programmably configured within a wider communication network 11 allowing remote or centralized functions in some optional instances such as for monitoring, reporting, status checking, software updates, security alarms, the conduct of financial transactions and so on. The present disclosure sets forth a variety of embodiments of electrical arrangements, mechanical configurations and logical operations of the present system and method, which are given by way of illustration and explanation only, and which may be modified or adapted by those skilled in the art to suit a given application.

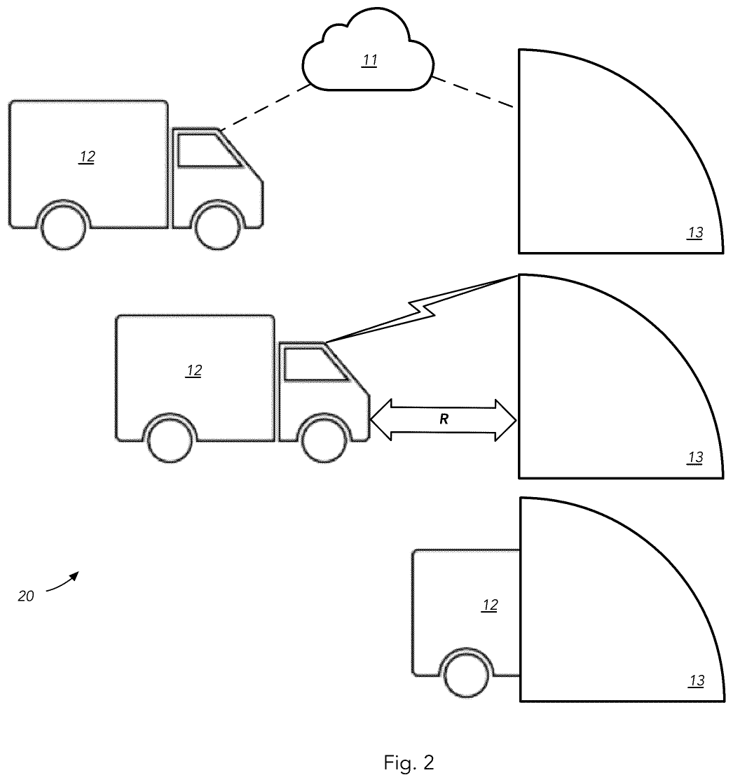

FIG. 2 illustrates an electric vehicle 12 as described, having a plurality of battery modules, in communication with a battery service station 13. The vehicle 12 or a connected battery monitor determines that some or all of the on-board battery modules are depleted or require charging or servicing. The vehicle 12, directly or through a networked management device is directed to approach said service station 13, which may be coordinated by selecting the nearest or most available service station with respect to the vehicle 12 location and/or condition. The timing and place of servicing the vehicle 12 can be automatically optimized and determined based on a known or programmed vehicle delivery schedule, route, traffic conditions, and material availability and needs of a given vehicle and service station pair, as in the upper panel. Wide-area network communications may take place between processor-based communications systems disposed in the vehicle systems or in mobile communication devices carried by the vehicle operator (e.g., a driver). In optional embodiments, shorter-range wireless communications are also possible between the vehicle 12 or its operator and the station 13 when the vehicle and station are within a given range R, as in the middle panel. Once the vehicle 12 is within or at said station 13, as in the bottom panel, one or more wired or wireless communication modes between said vehicle and said station are possible, including local Wi-Fi, Bluetooth or NFC communications using RF transceivers, tags and tag readers.

The present system and method identify a vehicle, operator, and/or equipment scheduled for or requesting a service at a service station, e.g., for swap of one or more depleted battery modules for charged modules, testing, repair or other battery system service. To effectively manage this process over a fleet of vehicles, subscribers and distributed systems, some or all components of the vehicle, battery system or other components are marked, tagged or indicated using identification information to differentiate them, track them or issue recall and similar notifications.

In an aspect, each present battery module is equipped with a uniquely identifiable wireless circuit, tag, transmitter and/or receiver. In an example, this can comprise a near field communication (NFC) tag. The tag uniquely identifies the associated battery module and when operated as designed creates a short-range electromagnetic or radio frequency (RF) field that encodes one or more parts of information relating to the respective battery module. The encoded information comprises an identifier or ID code or number that is readable by a NFC reader in the vicinity of the tag (e.g., on or near the vehicle, rack or other parts of the system).

In a non-limiting example, each BM on a rack may be identified, located, tracked and/or managed in the present context using its own unique four (4) byte ID code. Specifically, this can be used to dynamically generate network addresses and for control and communication among devices on said network including individual BM within the present battery rack system. Commonly, a CAN bus contemplates eight (8) bytes of data, therefore, in one aspect, the present system and method may dynamically generate a one (1) byte identifier for BM in the system when they are initially powered on and go through a system join handshake procedure. In this way, CAN devices can join a CAN network as described herein and acquire a one (1) byte identifier or temporary ID for communication with various other devices on the CAN network. A detailed explanation of the communication protocols for CAN networks is not required in this disclosure, and those skilled in the art can refer to the existing publications and standards and specifications associated with CAN network communications, which are considered incorporated herein.

As mentioned, a BM placed into the present rack system can be assigned a network ID as stated, which in part can be used to address and to locate said BM in said rack or CAN network (physically and/or logically). In one aspect, a combination of near field communication (NFC) and CAN network communication infrastructure can be used together to accomplish this location function. A BM having an ID as stated may join the CAN network in the rack system. A NFC tag within a BM placed in said rack system encodes or carries the ID code of the BM. A shelf controller of one of the shelves of the rack system detects the NFC delivered ID code using a NFC reader in said shelf controller. The shelf controller can then send the identifier of the BM to the present battery manager and/or other devices over the CAN network bus according to CAN network communication protocols. In this way, by pairing both a short-range wireless communication method (e.g., NFC) and a CAN communication method, the battery manager (or any networked control processor) can communicate with, exchange data with, monitor or otherwise manage the addressable BM placed in the present rack arrangement.

The wireless communication tags described may be also comprise passive devices that are excited by an electromagnetic or RF field from the tag reader and may include the several known or similar modes of communication such as those referred to as radio frequency identification tags (RFID). In optional embodiments, a wireless communication module or unit is an active system and enables two-way communication between each battery module and the rack system. The tags may optionally be powered, may comprise their own antennas and/or processing circuits, and may be programmable.

In an aspect, a single battery system service station can include a plurality of battery charging subsystems for replenishing depleted or partially depleted battery modules. Each such subsystem is coupled to and responsible for the charging, discharging, testing and electrical condition of one or more battery modules placed in electrical communication with its respective charging device. The several charging subsystems may in turn be monitored and controlled by one or more common charger collection managers and may comprise a hierarchical arrangement of one or more levels as shown and discussed below.

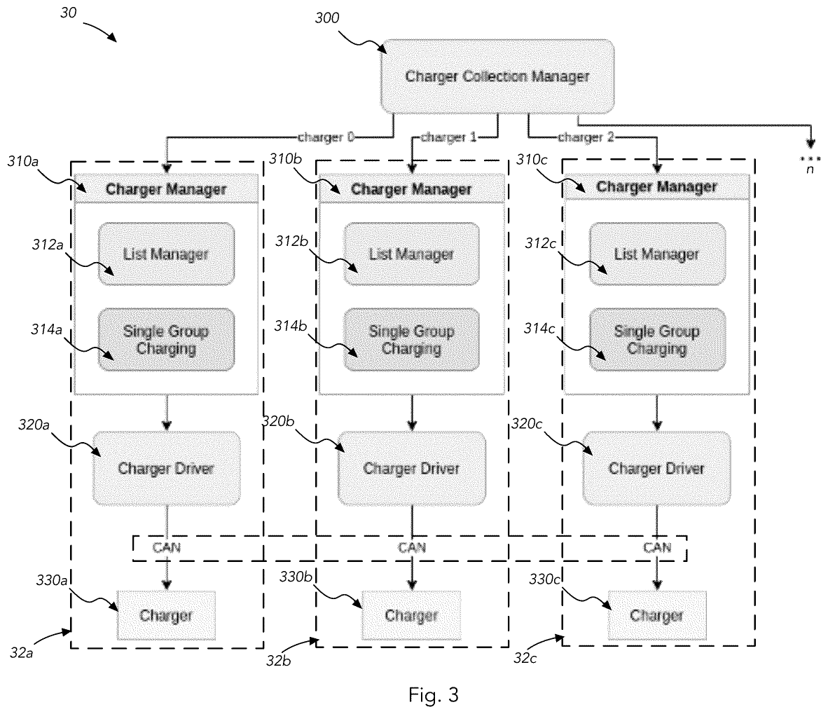

FIG. 3 illustrates a logical and/or physical arrangement 30 of a battery charging system, and accordingly a method, for managing the electrical state and charge of one or more swappable battery modules of an electric vehicle that can be grouped into one or more groups of battery modules. The system 30 includes a plurality of battery charging subsystems 32a, 32b, 32c . . . 32n (32). A charger collection manager 300 comprising controller and/or processing circuitry, and one or more connected charger managers 310a, 310b, 310c . . . 310n (310) managing the operation of their respective battery charging subsystems. The charger managers 310 comprise controller and/or processing circuitry, at the individual or group level, for charging, discharging, testing and electrical condition of a respective group of battery modules using at least a respective battery charger device 320a, 320b, 320c . . . 320n (320). Each charger manager 310 logically and/or physically comprises a list manager 312 and may comprise a single group charging manager 314. The single group charging manager 314 comprises a processor-based circuit, which may be physically constructed as a separate or the same as other processor circuits in this system, and which programmably controls and monitors and attends to the functions of a corresponding one of a plurality of defined battery module groups (a single such group).

Each charging subsystem 32 comprises a charger driver 320 which monitors and controls the operations and functioning and charging of one or more battery modules in a BM group on a rack of the present system as discussed herein. The charger driver 320 thus drives and controls a respective charger 330 that charges the one or more battery modules associated with or assigned to the charging subsystem 32.

The system 30 may be configured on or to employ one or more electrically conducting assemblies or buses in a buswork arrangement. In one aspect, a communication bus for carrying control and communication signals between the aforementioned components can be used as shown, without limitation. For example, a controller area network (CAN) bus 340 may be used to connect the components and conduct signals between them, including analog or digital signals. The format and communication protocols chosen may be selected to suit a given application, some of which are familiar to those skilled in the art and may in some embodiments follow protocols and industry standards set for such systems in the automotive, marine or other industries.

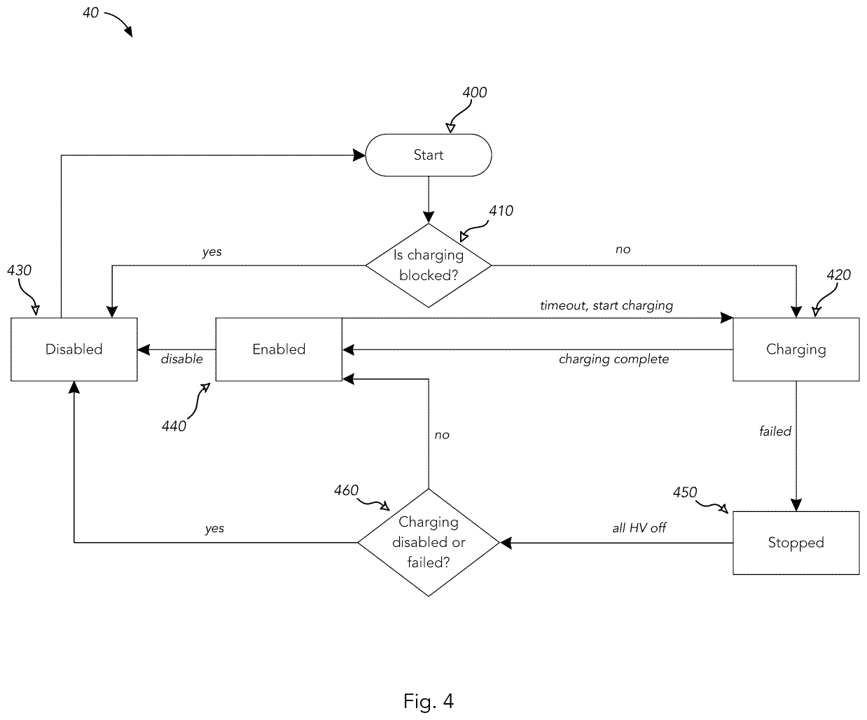

FIG. 4 illustrates an exemplary charger collection manager logic 40 for managing, programming or operating a charger collection manager 300.

We can consider the operation of the charger collection manager to begin at Start 400. An initial decision addressed at 410 is whether battery module charging is blocked or precluded. If so, then the battery charging is not possible, and the system will be in a Disabled state 430 and attempts to restart at 400 when possible. Otherwise, if charging is not blocked or precluded, the system can be in a Charging state 420.

If Charging 420 fails, the system stops the charging process and moves to the Stopped state 450. All high voltage (HV) inputs are switched off, for example for safety reasons, and the logic proceeds to a decision of whether charging remains disabled or failed at 460. If the system remains in a failed or disabled charging condition, the logic moves to the Disabled state 430, or if charging is no longer disabled or failed it can resume and the system logic moves to the Enabled state 440.

If the system is charging the one or more groups of battery modules and the charging is complete, the system moves from a Charging state 420 to the Enabled state 440 under normal conditions. Any event that disables the charging or where charging fails would put the system into the afore-mentioned Disabled state 430.

A timeout condition of the system can place it from an Enabled state 440 into a Charging state 420.

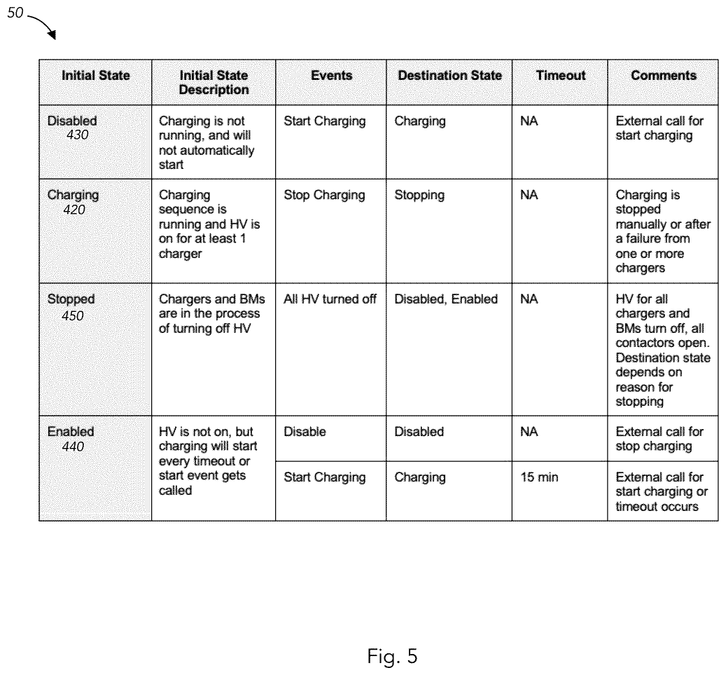

FIG. 5 illustrates an exemplary and non-limiting or exhaustive embodiment of a state chart 50 describing the various states of the charger collection manager and their transitions including Disabled 430, Enabled 440, Charging 420 and Stopped 450. It should be understood that the descriptions, parameters, time constants and details given in these examples are for the sake of illustration but are not limiting of the scope of the invention and other examples and equivalent embodiments will be apparent to those skilled in the art upon review of the present disclosure.

A given charger may be characterized by a Charging Factor (CF) within the present context. This factor is used to describe charging of a given group of battery modules and applies to a respective charger 330. The Charging Factor can be used to determine the group size of a given group of battery modules being assigned to the group or charged. In an example, a Charging Factor of zero can be a reference value for charging of a minimum group size (one battery module) in a swap operation, which minimizes the charge time for the next group of modules. A Charge Factor greater than zero in this context refers to additional size groups up to a design limit. The present system and method can define a minimum charging group size (e.g., minChargingGroupSize=20 BM) and other parameters such as a maximum BM charging current (e.g., maxBMChargingCurrent=3 Amps). Again, these examples are illustrative and not limiting of the scope of the present invention.

The present manager and method seek to exploit the optimum efficiency from the arrangement of chargers and controllers. In an aspect, we seek to maximize the output (power, current) provided safely by a given charger 330. That is, if a charger 330 is rated for x Amperes continuous output under given conditions then we seek to use the charger at x or near x Ampere output while charging using the charger 330. This way we can most effectively charge the largest number of battery modules and cells using the capacity of a charging system and service station with one or more such chargers. Referring to the discussion above, one optional embodiment may define a BM group size as:

chargingGroupSize=MIN(MAX(minChargingGroupSize,CF*(maxChargerOutputCurrent/maxBMChargingCurrent)),bmList.size( ))

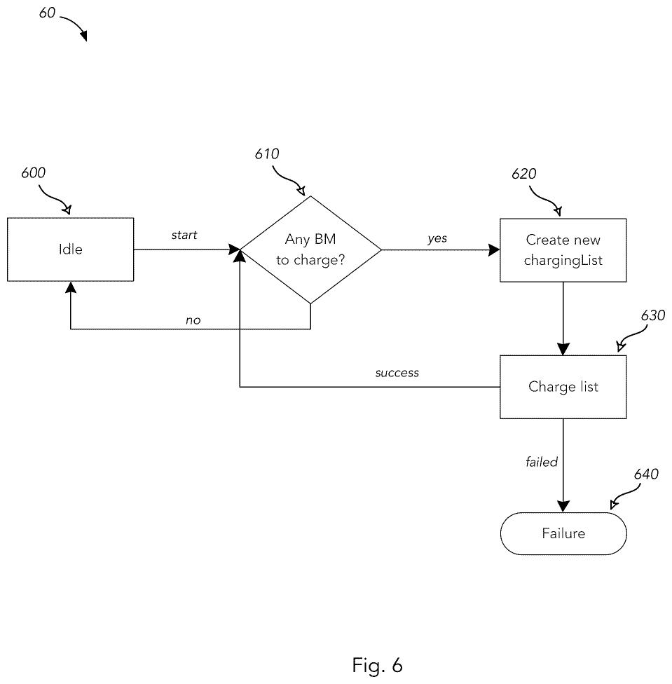

We now discuss exemplary aspects of the control and operation of the Charger Manager 310 of which a system 30 can include a plurality of such Charger Managers. FIG. 6 illustrates an exemplary embodiment of logic 60 for managing, programming and operating a charger manager 310 in the context of the overall present system and method. A charger manager 310 may have an Idle state 600, which can be the state in which the system or charger manager is started upon power-up or reset or in which it idles when no BM are presented for charging. Once operation starts, the decision is made whether any battery modules are present in the system and need to be charged at 610. In normal operation the answer could be Yes in which case a new charging list (chargingList) is created at 620. Details of the creation of chargingList are discussed herein by way of example and those skilled in the art can devise and extend these examples to similar and equivalent embodiments comprehended by this invention without loss of generality. The charge manager 310 directs its associated charger 330 to charge the BM members of respective chargingList group. So long as charging is successful, the system remains in the BM charging mode at Charge List 630 and can generate new BM groups for charging as described. If a failure occurs during the charging process, the charge manager 310 will be in Failed state 640.

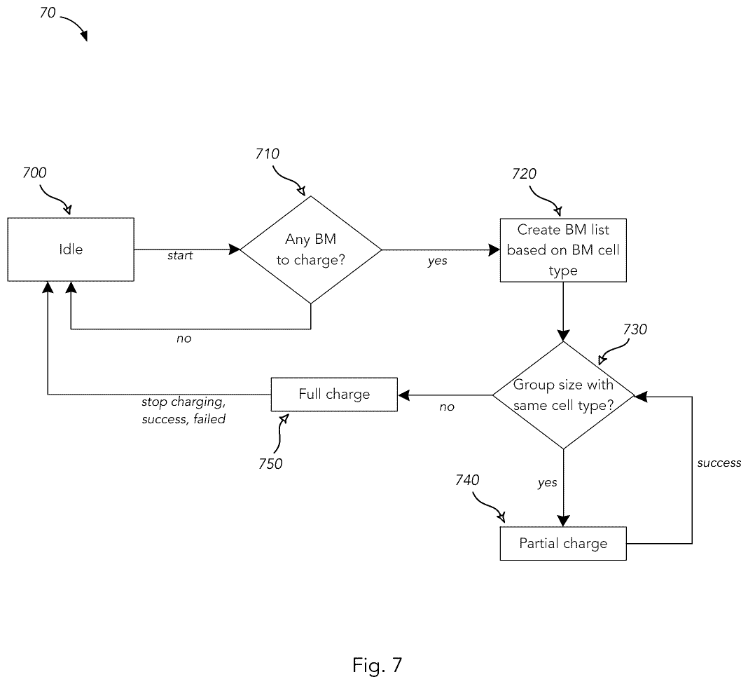

FIG. 7 illustrates a method, process or logic flow, which, as with other such flows can be programmed using machine readable instructions encoded into a digital storage unit for execution by one or more circuits of a processor. Here, the List Manager state machine's operation is depicted in an exemplary embodiment 70. The operation can be in an idle state 700 until a Start instruction or condition causes the operation to determine whether there are any BM to be charged at 710. If so (Yes) then a BM list is created based on the type of battery cells in the given BMs at 720. Cells of a similar type (e.g., chemical or other characteristic) are grouped together at 730, defining a single group charging that takes place at Partial charge state 740. If No then the state machine moves to Full charge state 750.

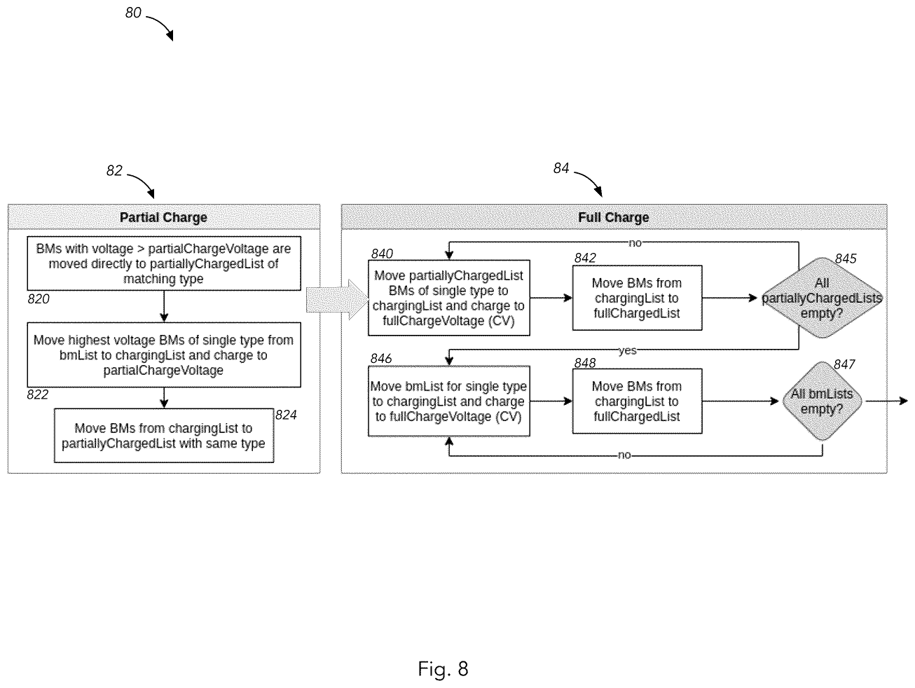

FIG. 8 illustrates steps of a process in partial or full charging of battery modules and moving from a Partial Charge process 82 to a Full Charge process 84. In the Partial Charge process 82 the system and method identify certain BMs with voltage greater than a set partial charge voltage (partialChargeVoltage) value and assigns these BM directly to a list (partialChargedList) of a given matching cell type at 820, which can theoretically be charged together using a same charger. At 822 the BMs having the greatest or highest voltage levels if the same single type are moved from the list (bmList) to the list (chargingList) and are charged by a charger to a set partial charge DC voltage (partialChargeVoltage). This charging may be carried out at full power of the charger or a constant current (CC) charging mode until the BM are charged to a set voltage. At 824 the BMs are moved from the list (chargingList) to the list (partiallyChargedList) with the same cell type.

The method can move from the Partial Charge process 82 to a Full Charge process 84. Here, at 840, we move BMs of a same cell type (which can be charged together using a same charger) from the list (partiallyChargedList) to the list (chargingList) and charge these BMs to a set full charge voltage in constant voltage (CV) charge mode. Then, at 842, these BMs are moved from the list (chargingList) to the list (fullChargedList) indicating BM in this group that are fully charged. If all of the partiallyChargedLists list is empty at 845 then the method and system move the list of BM (bmList) for a single type of BM to the list (chargingList) and charge these BM to a set full charge DC voltage (fullChargeVoltage) at a constant voltage CV at 846. Otherwise, if the partiallyChargedList at 845 is not empty, we return to state or step 840. When the BMs are charged as stated, they are moved from list (chargingList) to fully charged list (fullChargedList) at 848. This process continues until all of the BM lists are empty at 847. If not, the process returns to step or state 846, and if so, exits.

In an aspect, the above process enables separate lists of battery modules which are partially or fully charged. This can optimize system performance for improved battery life and overall battery cell health. The switching from constant current charging mode (CC) to constant voltage charging mode (CV) is possible and useful in some embodiments to avoid over voltage conditions when the cells and/or modules reach or exceed a certain DC voltage point by slowing down the charging rate.

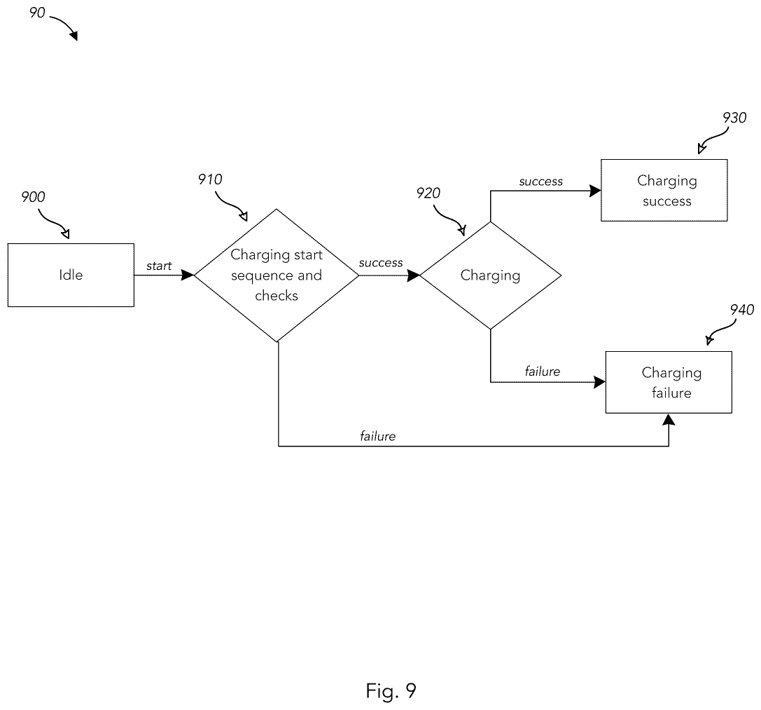

FIG. 9 illustrates an overview of a process 90 for charging according to embodiments of the present invention, which may be embodied in a single BM group charging state machine. In this non-limiting example, which can be reasonably modified and enhanced with sub-steps of a method, the method and system are in an idle state at 900. When the charging process starts it executes one or more steps in a charging start sequence as best determined by a specific implementation of the invention or case at hand, and initialization checks are performed at 910. Successful start and checks lead to Charging State at 920 where the system instructs the chargers to charge the assigned battery units as described. Failure of the initialization start and/or checks results in a Charging Failure state at 940. While charging, success in charging the groups of BMs as described results in a Charging Success state at 930, or a Charging Failure state 940 if an error or fault occurs during charging.

In one or more embodiments, the present system and method comprise a single battery module group charging state machine, which may take the form of a specialized processor circuit or circuits, or may be implemented within general processing circuits executing machine-readable stored instructions encoding the present functionality, input data and other information to cause the processors to generate output signals responsive to said instructions and input data. The operation of the single BM group charging state machine may be controlled by a master controller or Battery Manager device as described. A full system according to the invention may thus comprise more than one single BM group charging state machines.

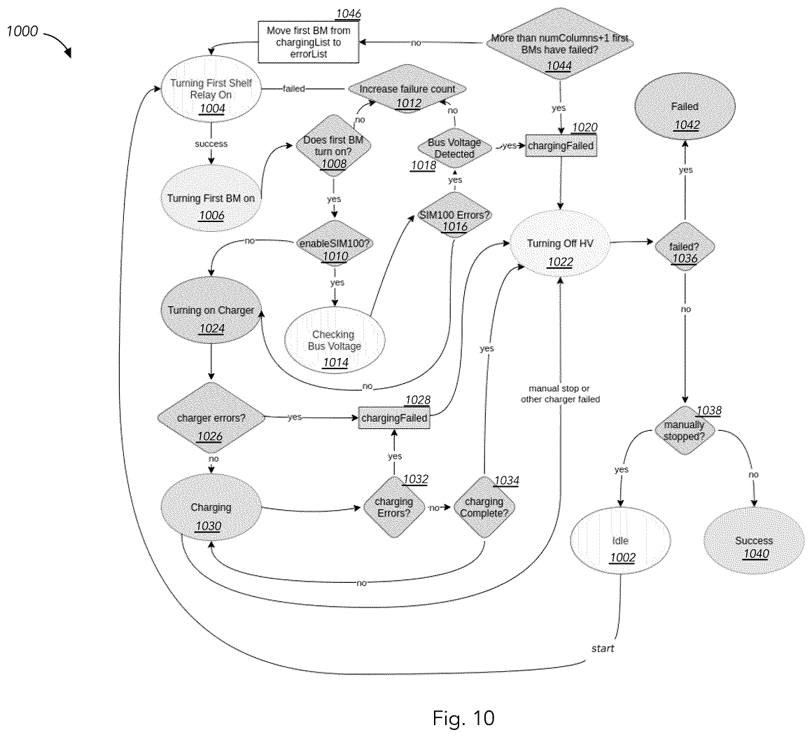

FIG. 10 illustrates an exemplary process and method 1000 carried out at least in part in said single group charging state machine. As before, we can consider the start of the process from an Idle state 1002 after which a first shelf containing one or more BM for charging is turned on by switching its shelf relay to ON at 1004. The activation of a shelf relay is but one way to initiate charging of a group of BM. Activating the shelf relay at 1004 will prepare a first BM in a charging list for charging on that shelf at 1006. If said first BM turns on and is ready to charge (1008) then SIM100 is enabled at 1010 and the charging bus voltage is checked at 1014. If there are no SIM100 errors (1016) the charger coupled to said shelf and BM(s) is turned on and provides high DV charging voltage as determined at 1024. The method and system continue to monitor for charging errors at 1026. So long as charging is required and there are no reported charging errors (1026) the system and method will charge the designated BM on said shelf of the rack of the system as described at 1030. Any charging errors (1032) will cause a chargingFailed state at 1028 and will turn off the high voltage (HV) charging to the shelf at 1022. Also, if the charging is deemed complete at 1034 the high voltage is likewise stopped. The failure (1036) event will place the system or a subsystem thereof that failed in the Failed state 1042. Manual stopping of the charge process is possible and if manually stopped at 1038 the system can be returned to its Idle state 1002, or if the stopping was not caused by a manual stop (1038) the system will be in a charge Success state 1040.

Checks and fail safe events are contemplated as well. For example, in addition to those processes described above, the method and system may detect a failure to turn on the shelf relay at 1004, which will increment a failure count at 1012. Failure count increase 1012 is also triggered if there is a failure to turn on the first indicated BM at 1008 or if the bus voltage is not detected at 1018. If no bus voltage is detected at 1018, a chargingFailed condition 1020 will turn off the high voltage (HV) supply to the shelf at 1022.

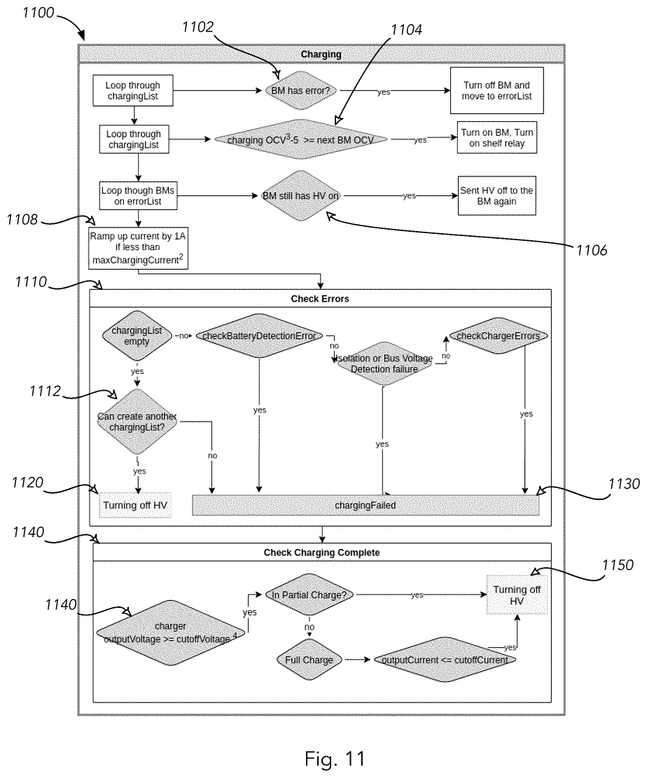

FIG. 11 illustrates an exemplary process 1100 for charging a single group of battery modules according to an embodiment. A list of battery modules is created in chargingList as described earlier, and the system and method can loop through the chargingList modules, checking at each one whether there is a BM error at 1102. If an error does exist in that BM then that BM is turned “Off” and the process continues with the other BM of the list chargingList. Also, the system and method checks at 1104 for, and if so then the BM is turned “On” and the shelf that the BM is on is also turned on by activating or turning on that shelf's relay. The system and method loop through a list of BM errors (errorList) and check if the BMs with errors continue to have high voltage (HV) available at 1106, and if so the HV to that BM is turned off. The charging current is ramped up (increased gradually) by a reasonable amount (e.g., by 1 Ampere) if the charging current to a BM is less than a set maximum charging current (maxChargingCurrent) at 1108.

The system and method perform error checking and track errors at 1110. The list of BM in chargingList is checked and new lists can be created at 1112. The method and system are able to engage the Turning off HV state 1120 and a charging failure (chargingFailed) state 1130 if and when necessary.

The method and system check for charging completeness at 1140, for example if a BM output voltage is above a set cutoff voltage at 1142. If charging is determined to be completed, the high voltage DC charging (HV) is turned off to a BM that has completed its charge.

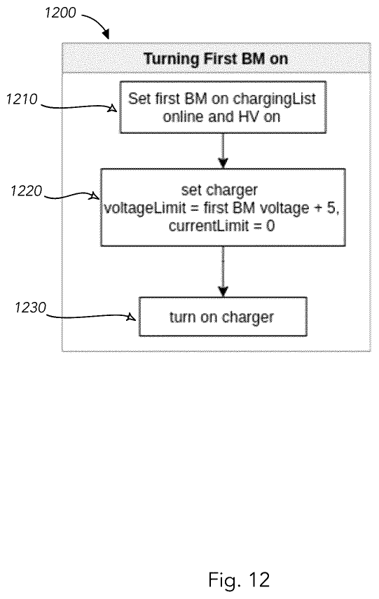

FIG. 12 illustrates exemplary steps of a process 1200 for turning on a first battery module (BM) by setting a chosen BM from a list of modules in a single group to be charged, e.g., in chargingList at 1210. The charging voltage limit is programmably set at 1220 in an example as voltageLimit=(firstBMvoltage)+5 VDC. The charging current limit is programmably set to zero, currentLimit=0 Amps. The corresponding charger is then activated or switched on as described elsewhere herein to achieve charging of the first BM at 1230.

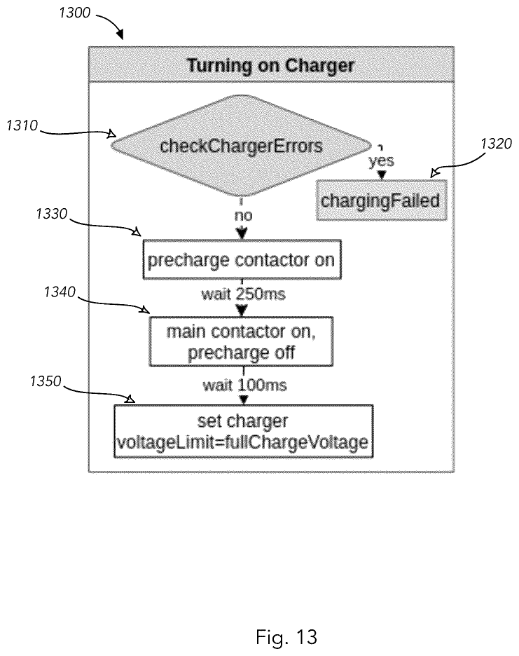

FIG. 13 illustrates exemplary steps of a process 1300 for turning on a battery charger as described in various embodiments herein. The system and method check for charging errors at checkChargeErrors 1310, which like other flags and states herein, may be in the form of electronic signals, stored data bits in a machine-readable storage medium or other digital and/or analog encoded signals. If errors are found at 1310 then the chargeFailed state 1320 is entered. Otherwise, a pre-charge contactor is turned on, closed or activated at 1330. After a brief delay, e.g., 250 milliseconds, a main contactor is turned on and the pre-charge is ended at 1340. After another brief delay, e.g., 100 milliseconds, the relevant battery charger on the rack system is set to full charging operation and a charging voltage limit is set to full charge voltage as programmed at 1350.

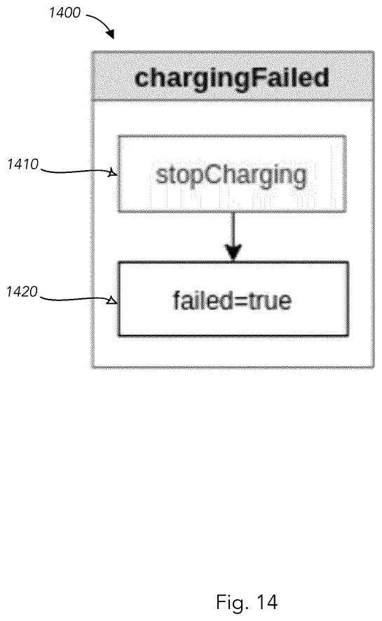

FIG. 14 illustrates a simple state where there exists or is flagged a charging failure (chargingFailed) 1400 as mentioned herein. The method and system stop charging at 1410 and a state or flag “failed” is set to “true” (or another binary value such as Yes or 1 or any equivalent indication) at 1420.

While the specifics of the given examples are not limiting and modifications are possible within the scope of this invention, the system and method have ample failure monitoring and automatic shutdown triggers to avoid damage to the battery module cells (e.g., over-voltage, over-current, over-heating) and to avoid other electrical and/or mechanical failures to the charging and battery service hardware. Error or alert messages may be generated upon the occurrence of any such failures, which may be transmitted over a wide area network (e.g., cellular or internet) to a server or system operator as appropriate.

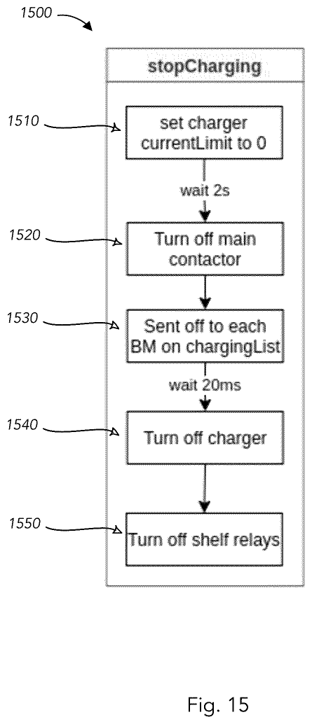

FIG. 15 illustrates an exemplary charge stopping process 1500 for securing from a battery charging state in an electric vehicle charging system as described herein. The example shows a stopCharging set of steps with some dependencies that are optional or can be modified to suit a given implementation. Here the charger current limit is set to zero Amps by setting a variable currentLimit to 0 at step 1510. After a pause (e.g., about 2 seconds) a main contactor to the charger is turned off at step 1520. Step 1530 sends an “OFF” signal to each battery module BM on the charging list chargingList.

After another brief delay (e.g., about 20 milliseconds) the charger in question is turned off at step 1540. The associated shelf relays are turned off at step 1550. It should be understood that the timing of the exemplary delays is merely for the sake of illustration and the specific materials and methods used in a given instance could inform a different time delay than the ones shown in the example.

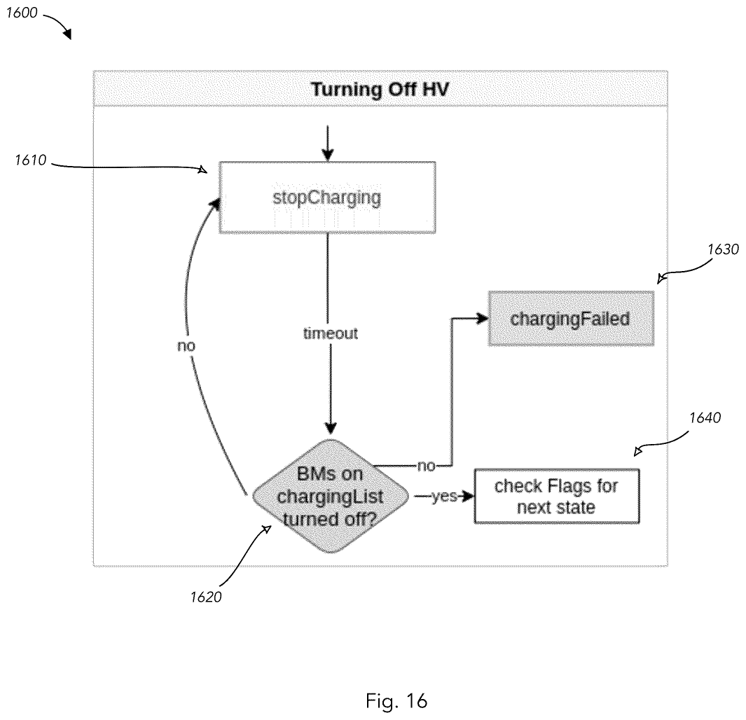

FIG. 16 illustrates an exemplary process 1600 for securing or turning off the high voltage (HV) DC power to all or part of the present system in an illustrative embodiment. A stopCharging signal or state is activated at 1610. A timeout as described above comprising a set time delay is clocked out and the logic checks if the battery modules in the chargingList have been turned off at 1620. If the BMs on the chargingList have not been turned off the system returns to the stopCharging 1610 state and a chargingFailed condition or signal 1630 is flagged. If the BMs in the chargingList have been turned off then the system checks any flags for a next (in time) state at 1640.

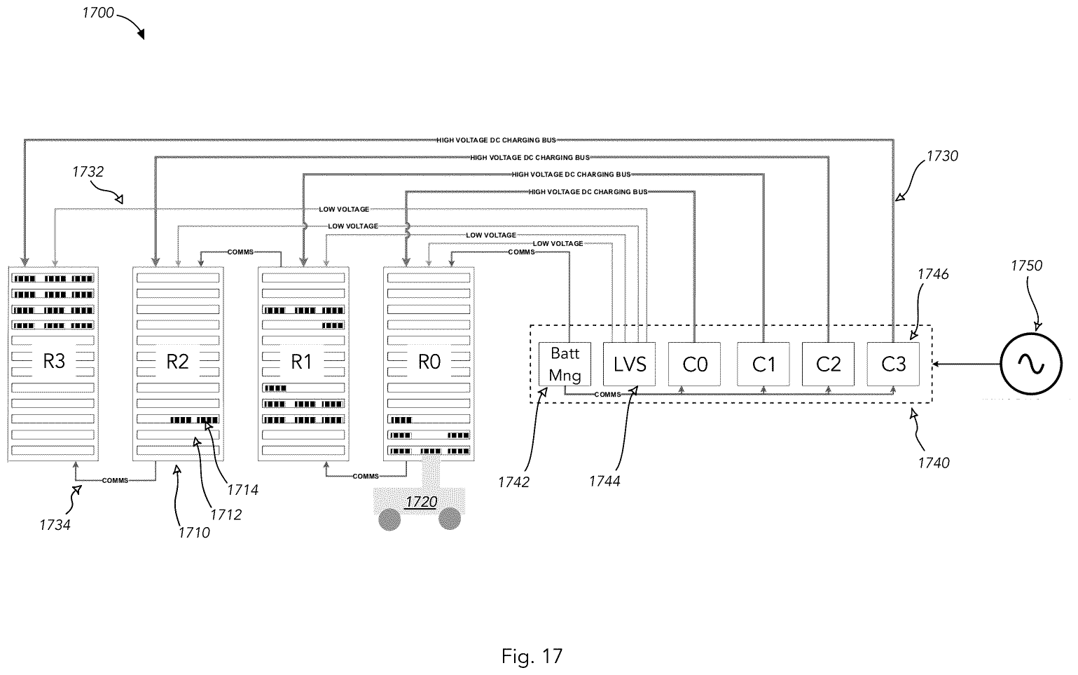

FIG. 17 illustrates a system level overview of a rack-based system 1700 for charging, monitoring, and maintaining a plurality of batteries such as for powering an electric vehicle. In an aspect, the present system is provided in a form factor such as a vehicle service pod or station that encloses the system 1700. An electric vehicle may be driven into, or the system 1700 may be positioned on, about or proximal to said vehicle so that one or more swappable battery modules from said vehicle can be removed from the vehicle and placed onto the racks as shown for service or charging.

One or more racks 1710 (R0, R1, R2, . . . ) are configured and arranged with mechanical and electrical features as described herein. Each rack 1710 comprises a plurality of shelves 1712 wherein a shelf is configured and arranged mechanically to accept one or more battery modules (BMs) 1714 thereon and is configured and arranged to provide electrical DC power to said BMs and to communicate data regarding the state of the BMs and to communicate control signals as described herein.

A robotic system or manipulator arm, conveyor or other electro-mechanical means 1720 for carrying and placing the BMs 1714 is provided and is configured and arranged to swap individual BMs or groups of BMs in and out of the rack system 1700 and/or in and out of an electric vehicle being serviced or refueled (receiving replacement batteries).

Once the BM 1714 is on a designated place on a shelf 1712 of a rack 1710 the BM 1714 is mechanically secure and is electrically connected to the electrical DC high voltage and communication buses running through the rack system as described herein. For example, using the system's high voltage DC charging bus 1730, the system's low voltage bus 1732 or the system's communication bus 1734, e.g., a CAN bus.

In addition, the system comprises a battery manager 1742, a low voltage supply/source 1744 and one or more battery chargers 1746 (C0, C1, C2, . . . ) as described herein. In an embodiment, these components may be housed in an electrical control box or unit 1740 for protection of the components (e.g., from the elements and from tampering) and for protection of other equipment and personnel.

The system 1700 and its electrical infrastructure may be powered from a variety of power sources 1750. In an example, these comprise transformed AC power from an electrical grid that is converted to 480 VAC. But other embodiments are possible, including power from a local or remote generator, solar installation, wind, or other sources of electrical power as understood by those skilled in the art.

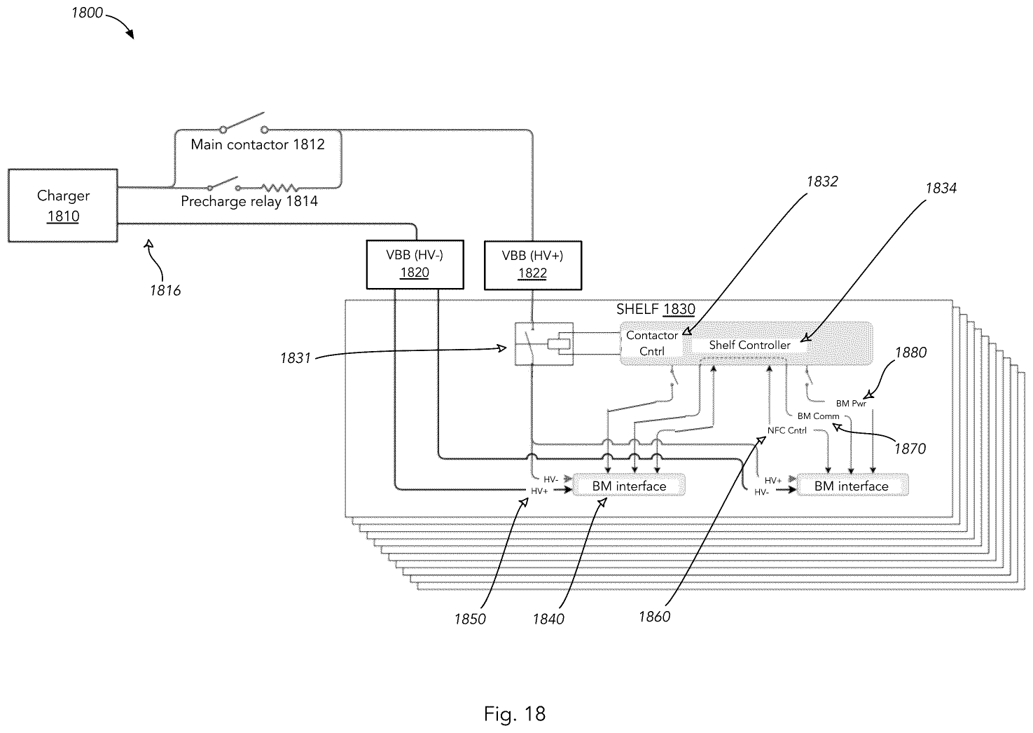

FIG. 18 illustrates a shelf unit and controls 1800 of the afore-mentioned rack based battery control and service system. A charger 1810 such as those described earlier delivers DC charging power over DC buswork 1816 to vertical bus bars 1820 (HV−) and 1822 (HV+) through a main contactor 1812 and a precharge relay 1814, which are switched and disposed in said buswork 1816. The shelf 1830 may be as described in this disclosure and illustrated at 1712 in the previous drawing with respect to a multi-shelf rack in a rack-based system 1700. Preferably, but not necessarily, each shelf 1830 is equipped with its own mechanical and electrical and communication hardware for supporting the charging, monitoring and maintenance of one or more battery modules BM placed thereon. HV− (DC negative) and HV+ (DC positive) bus connections 1850 are provided in the shelf 1830 for charging the BM at a given high DC voltage level. A control circuit or circuits are provided in said shelf 1830 including a shelf controller 1834, a contactor controller 1832 to control main contactor 1831. One or more BM interfaces 1840 couple the shelf controller 1834 and the HV buses 1850 and may comprise in said interface a near field communication (NFC) controller and control line 1860, a BM communication line 1870 and a BM power switched connection 1880.

As can be appreciated, significant flexibility is provided hereunder by use of the present configurable system and method especially as it is connectable and able to be scaled and networked across an infrastructure of such devices and methods. Where processor-controlled, the invention can act based on program logic embedded in hardware and/or software or related executable instructions. State machines are usable to monitor and manage several aspects of the system and battery modules and eventual operation of the associated vehicles. Account security and financial transactions are likewise accessible and controllable through the present system and method for the same reasons.

A dedicated system comprising a rack or array of racks for managing, servicing, testing and recharging electric vehicle batteries is thus provided. The system includes a battery manager and can test and simulate battery drive cycles while the batteries are on the rack (not in the electric vehicle) using dummy loads (rather than the vehicle's electric loads). A physical model is used to model the dynamic power limits, keep the batteries from experiencing over-voltage or under-voltage conditions and to ensure system and equipment safety. Several communication channels are implemented to coordinate and control the power delivery to and from the rechargeable batteries, to monitor the performance and operating parameters of the system among the several controller circuits therein and in each battery module, and to wirelessly communicate with an electric vehicle and/or user being serviced by the system.

A host of useful and novel servicing, charging, testing and other methods can be applied to a multi-battery module arrangement carried by electric vehicles and serviced by the present system.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will appreciate the many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments may be implemented in numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory, one or more data storage discs, optical discs, magnetic tapes, flash memories, circuit configurations in field programmable gate arrays or other semiconductor devices, or other tangible computer storage medium) encoded with one or more programs that, when executed on one or more computers or other processors, perform methods that implement one or more of the various embodiments described above.

Computer-executable instructions may be used to control one or more processors and circuits used with this invention and may be provided in many forms, such as program modules, executed by one or more computers or other devices. The functionality of the program modules may be combined or distributed as desired in various embodiments.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

We claim:

1. In an electric vehicle battery service station, a system for servicing a plurality of electric vehicle battery modules, the system comprising:
an electro-mechanical rack assembly comprising one or more battery racks, each battery rack being arranged and configured to receive and hold one or more of said plurality of electric vehicle battery modules for servicing or storing in said battery rack, wherein said battery rack includes a plurality of battery module compartments, and wherein each of said compartments is configured and arranged to hold one of said electric vehicle battery modules, and each said compartment further comprises one or more electrical connection points configured and arranged to electrically couple to corresponding electrical connection points on an electric vehicle battery module therein;
a plurality of battery chargers, one battery charger per battery rack, wherein each charger provides direct current (DC) electrical power to charge one or more battery modules disposed in the corresponding battery rack;
a plurality of charger managers, one charger manager per battery rack, where each such charger manager comprises processing circuitry and is coupled to and is in data communication with at least said battery chargers so as to control said battery chargers according to program instructions within said charger manager, each of said charger managers further coupled to and in data communication with a corresponding respective list manager that comprises circuitry and instructions to determine a list of said battery modules coupled thereto;
a charger collection manager coupled to and in data communication with each of said charger managers, where said charger collection manager comprises processing circuitry and executed program instructions within said charger collection manager to control said charger managers.
